(19) United States
(12) Patent Application Publication
(10) Pub. No.: US 2004/0251101 A1
(43) Pub. Date: Dec. 16, 2004

(54) Differentiated-jump servomotor

(76) Inventors: Juan Simon Bacardit, Barcelone (ES); Fernando Sacristan, Barcelone (ES)

Correspondence Address: Leo H McCormick Jr, 2112 Mishawaka Avenue, PO Box 4721, South Bend, IN, 46634-4721, US

(21) Appl. No.: 10/478,579

(22) PCT Filed: May 23, 2002
(86) PCT No.: PCT/FR02/01731

(51) Int. Cl. B60T 11/00

(52) U.S. Cl. 188/355

(57) ABSTRACT

The invention provides a braking pneumatic servomotor (10), of the type comprising a moving piston (22) biasing an actuating rod (34) for a master cylinder (28) as a result of the actuation of a plunger (56), a front face of which traverses the piston (22), constitutes a first finger (62) and, when the plunger (56) is in the end actuation position, is capable of penetrating a reaction disk (44) interposed between the piston (22) and the actuating rod (34), so as to transmit the reaction force from the master cylinder (28) to the plunger (56), characterised in that it comprises a second finger (68) which, when the control rod (46) is actuated at a higher speed than a determined speed, is capable of being locked by a unidirectional clutch device (70) in an axial position, which is determined in relation to the piston (22), and then of being driven by the piston so as to cause the second finger (68) to penetrate the reaction disk (44), in order to enable the first finger (52) to apply a braking force more quickly.

This invention relates to a pneumatic servomotor for the actuation of a braking master cylinder intended for a motor vehicle.

More particularly, the present invention relates to a pneumatic servomotor for the actuation of a braking master cylinder in a motor vehicle, of the type comprising a rigid casing, in which a transverse partition wall is movable, thus defining in an airtight manner a front chamber under a first engine negative pressure, and a rear chamber under a second pressure, varying between the engine negative pressure and the atmospheric pressure; of the type including a moving piston, integral with the moving partition wall and a front face of which is capable of biasing an actuating rod for the master cylinder; of the type including a control rod for the servomotor, moving inside the piston in a selective manner as a function of an axial input force, exerted in the forward direction against a return force applied to the rod by a return spring; of the type comprising a plunger, which is arranged at the front part relative to the control rod inside the piston, and which comprises at its rear end at least a rear annular seat of a three-way valve, gradually movable between a position in which, the control rod being at rest, the front chamber and the rear chamber are interconnected, and a position in which, the control rod being actuated, the second pressure, prevailing within the rear chamber, increases because the valve connects the rear chamber with the atmospheric pressure; and of the type comprising a first finger, which constitutes the front end of the plunger and traverses the piston, and which, in the rest position of the control rod, is disposed at a first determined jump distance from a reaction disk, interposed between the actuating rod for the master cylinder and the front face of the moving piston and which, when the control rod is actuated at a speed which is lower than a determined speed, is capable of being biased by the plunger so as to cover the first jump distance and then penetrate the reaction disk in order to transmit the reaction force from the master cylinder to the plunger and to the control rod.

Numerous examples of such conventional servomotors are well known.

In such a servomotor, the distance between the first finger and the reaction disk is called the “jump distance” and it corresponds to the theoretical distance which the first finger must cover before the driver of the motor vehicle may actually feel the reaction force from the master cylinder.

However, it is quite usual that, when there is a clearance between the first finger and the reaction disk, such distance will correspond to the distance from the first finger to the reaction disk but, if the reaction disk is initially decompressed, this distance may also correspond to the travel which is required for the first finger to compress the reaction disk till the latter is fully compressed.

In a full-braking situation, in which case a maximum braking force is applied to the control rod, the actuation of the control rod causes the first finger-forming plunger to be moved, which fact results in the maximum opening of the three-way valve and, therefore, the rear chamber is subjected to the atmospheric pressure. Thus, the moving partition wall travels forwards and the end of the first finger-forming plunger compressively penetrates the reaction disk, made of an elastomeric material and integral with the rear face of the moving piston.

Therefore, the force, which is applied to the actuating rod for the master cylinder when the control rod reaches the end of its stroke, results from the assistance force, arising from the pressure difference between each side of the moving partition wall, and from the force exerted by the finger-forming plunger on the reaction disk. Besides, the driver feels the braking reaction force, which is transmitted from the master cylinder to the plunger, through the reaction disk.

As a matter of fact, it has been established that quite a number of drivers, when confronted with an emergency braking situation, underestimated the risks actually incurred and, after having jammed the brakes on, would release the braking force at the very time when a braking force should have been maintained in order to avoid an accident.

In the case of a full-braking situation, accompanied by the swift travel of the control rod, the plunger may touch the reaction disk and therefore give the driver the feeling of a maximum braking action even before the pressure difference between the front and rear chambers actually reaches its maximum value, which may lead the driver to release the braking force even though it should be maintained so as to profit by the maximum braking force.

In order to cope with said difficulty, a servomotor has been provided, wherein a first finger is slidably mounted in relation to the plunger, so as to penetrate the reaction disk, and which, when the control rod of the servomotor is actuated at a determined speed, is capable of being locked in relation to the moving piston, so as to maintain a maximum braking force on the actuating rod for the master cylinder, by means of the reaction disk, even though the driver may have released the braking force in part.

Such a design has the disadvantage of requiring quite a high force from the driver owing to the fact that, for the finger to penetrate the reaction disk at the end of the stroke, the actuating force must be exerted against the reaction force from the master cylinder.

It is a serious disadvantage in an emergency braking situation, that is when a braking force must be exerted at once with an actuating duration which must be as short as possible.

This invention copes with the disadvantages of the above-mentioned two designs, in that it provides a servomotor according to the first design, further comprising a second finger which, on a quick application of the braking force, may be pushed by the plunger and axially locked in relation to the piston, and then be pushed by the piston into the reaction disk so as to permit such quick application of the braking force, with a new jump distance having a greater value than the initial one, while meeting but a reduced counter-force transmitted by the reaction disk, for a quicker application of the braking force.

To this end, the invention provides a servomotor of the above-described type, characterised in that it comprises a tubular sleeve, slidably fitted on the plunger, having a front section traversing the piston and an end of which bears a second finger, wherein, when the control rod is actuated at a higher speed than a determined speed, said sleeve is capable of being pushed by the plunger and locked by a unidirectional clutch device in an axial position, which is determined in relation to the piston, and then of being driven by the piston so as to cause the second finger to penetrate the reaction disk, in order to enable the first finger to apply a quick braking force against a reaction counter-force from the master cylinder, which is reduced on a second determined jump distance, which is greater than the first jump distance.

According to other features of this invention

the sleeve comprises a rear tubular section, which is slidably fitted within a complementary-shaped rear bore provided in the piston;

the unidirectional clutch device comprises a key, fitted inside a cavity provided in the piston and traversing the piston, perpendicularly to its axis, and a substantially annular intermediate portion of which surrounds the sleeve with some clearance and is capable of being driven by the moving piston, when the input force is applied to the control rod at a speed, which is higher than the determined speed, so as to rock about a generally transverse axis, in order to cooperate with the periphery of the rear tubular section of the sleeve, thus locking said sleeve in a determined axial position;

the rear tubular section of the sleeve comprises at least one locking transverse face, axially facing rearwards so as to constitute a stop for a peg provided on an upper portion of the key and extending radially towards the sleeve, for an axial indexing of the determined locking position of the sleeve and of the second finger;

the rear section of the sleeve comprises a groove exhibiting a substantially truncated-cone-shaped profile, a shoulder-forming front face of which constitutes the locking transverse face;

the peg provided on the key has, in an axial sectional view, the shape of an angular sector, which is complementary to the truncated-cone-shaped profile of the groove provided in the sleeve;

the key comprises a substantially L-shaped lower portion, diametrically opposite the peg, extending radially from its annular portion and resiliently biased against a stop-forming face provided in the casing of the servomotor, through a return spring, arranged between a front face of the cavity provided in the piston and a front face of said lower portion;

the second finger has a greater outer diameter than that of the rear section of the sleeve;

the reaction disk is received within a cup, coaxial with the piston and integral with the rear end of the actuating rod, and a rear tubular portion of which is slidably fitted inside an annular groove, coaxial with the front face of the piston;

the key has substantially, in an axial sectional view, the shape of a tee, the vertical branch of which is substantially radially directed and comprises the annular intermediate portion and the substantially L-shaped lower portion, whereas its upper horizontal branch bears the peg, which protrudes from its front end, and is received, with some clearance, between two opposite walls of the cavity provided in the piston.

Other features and advantages of the present invention will be apparent from the following detailed description, when taken in conjunction with the accompanying drawings, in which:

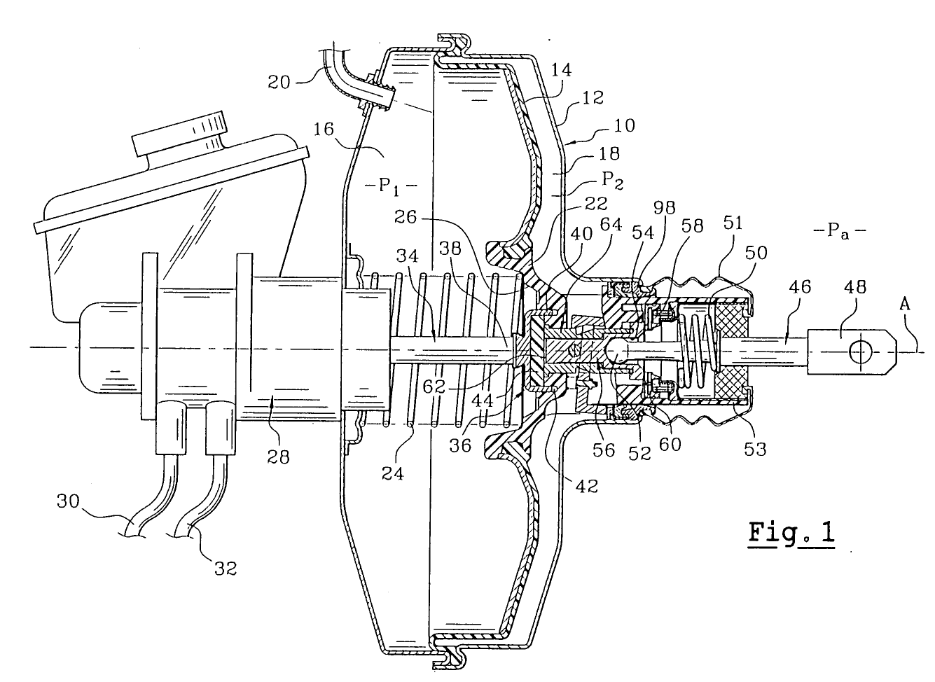

FIG. 1 is a general axial sectional view, showing a pneumatic servomotor for an assisted braking according to this invention;

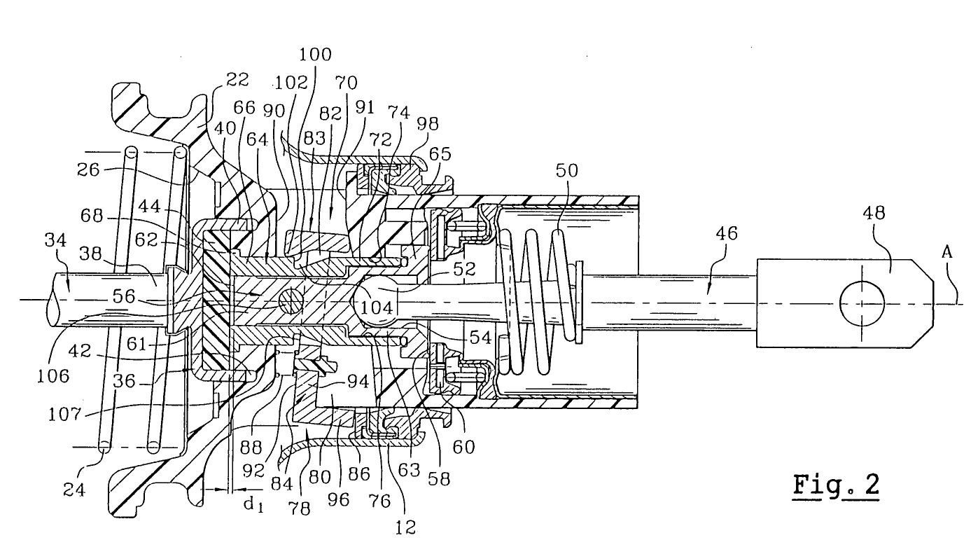

FIG. 2 is a detail axial sectional view of the servomotor shown in FIG. 1, represented in the rest position of the control rod;

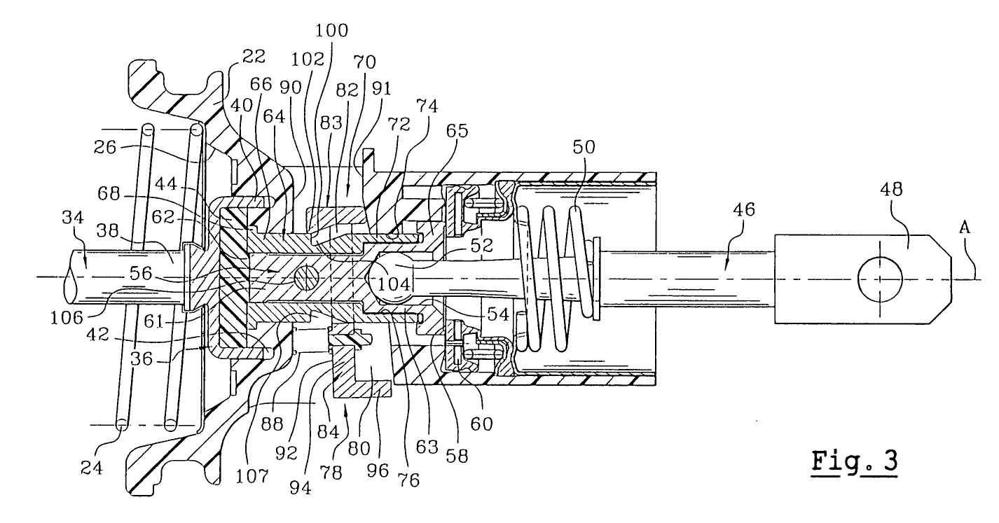

FIG. 3 is a detail axial sectional view of the servomotor shown in FIG. 1, when a braking force is applied to the control rod at a slow speed;

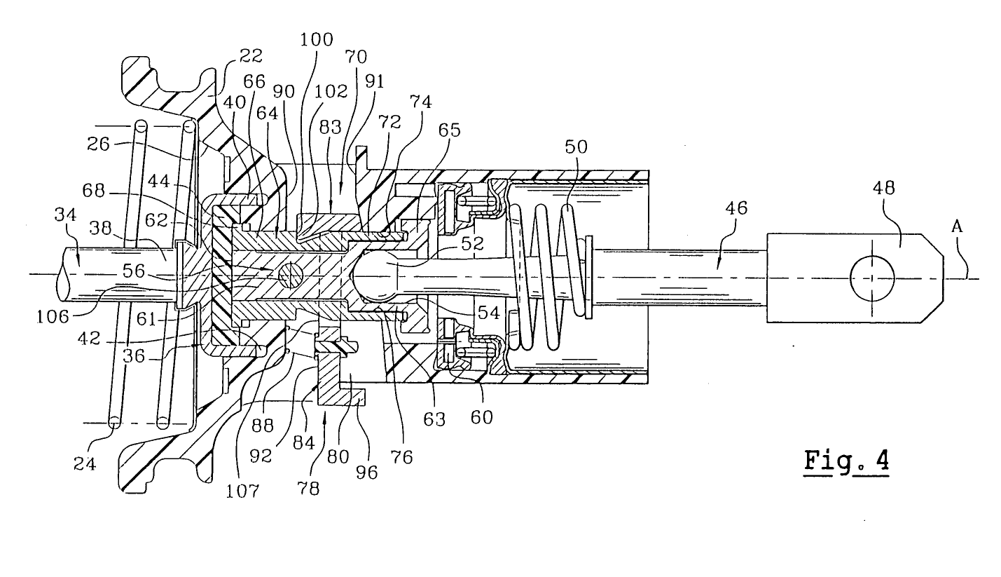

FIG. 4 is a detail axial sectional view of the servomotor shown in FIG. 1, when a braking force is applied to the control rod at a high speed, in a first step of initial actuation of the control rod; and

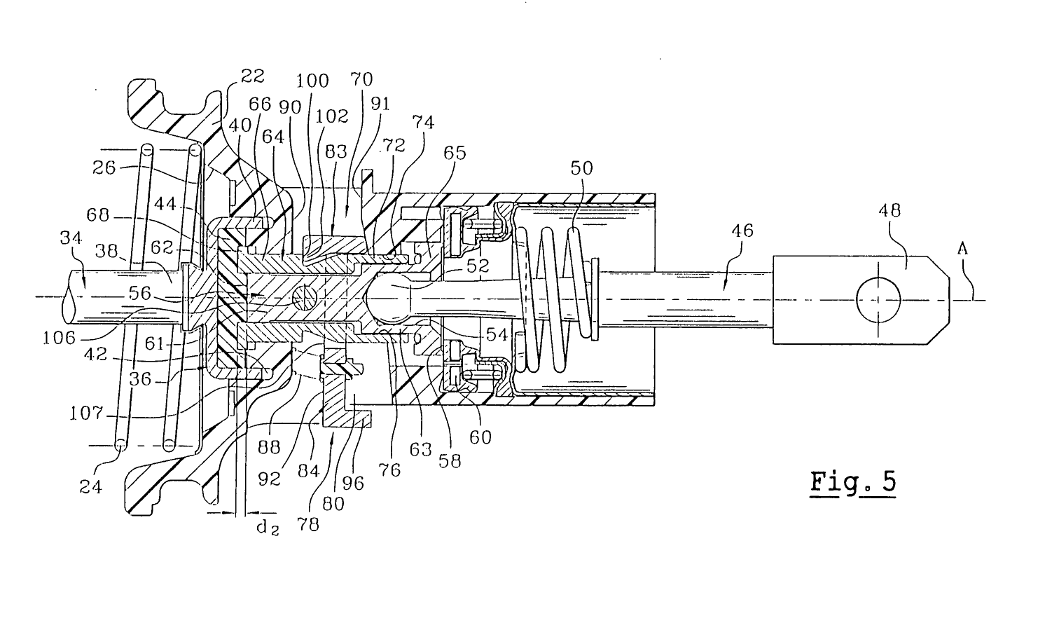

FIG. 5 is a detail axial sectional view of the servomotor shown in FIG. 1, when a braking force is applied to the control rod at a high speed, in a second step of intermediate actuation of the control rod.

In the following description, the same reference numerals will designate the same elements, or elements having similar functions.

As a rule, the terms “front”, “rear”, “upper” and “lower” refer respectively to elements or positions facing leftward, rightward, upward or downward in FIGS. 1 through 5.

FIG. 1 illustrates a pneumatic servomotor 10 for an assisted braking of a motor vehicle.

In a well-known manner, the pneumatic servomotor 10 comprises a rigid casing 12, in which a transverse partition wall 14 is movably mounted, so as to define, in an airtight manner, a front chamber 16 under a first pressure “P₁”, the value of which is equal to the negative pressure value of the vehicle engine, and a rear chamber 18 under a second pressure “P₂”. Said second pressure “P₂” may vary between the engine negative pressure value “P₁” and the atmospheric pressure “Pₐ”, as will be further explained hereunder.

The front chamber 16 is supplied with the pressure “P₁” through a negative-pressure pipe 20, connected for instance to an inlet manifold (not shown) of a vehicle engine.

The pneumatic servomotor 10 comprises a moving piston 22, integral with the moving partition wall 14. Inside the casing 12, the moving partition wall 14 is resiliently returned by a return spring 24, which rests on the casing 12 and on a front face 26 of the moving piston 22.

The servomotor 10 is coupled to a braking master cylinder 28 which is also connected to a braking circuit of the vehicle through hydraulic pipes 30 and 32.

More particularly, the front face 26 of the moving piston 22 is connected to an actuating rod 34 for the master cylinder 28 through a cup 36, which is coaxial with the piston 22 and integral with the rear end 38 of the actuating rod 34, and a rear tubular portion 40 of said cup is slidably fitted in a coaxial annular groove 42 provided in the front face 26 of the piston 22. The cup 36 accommodates a reaction disk 44, made of an elastomeric material, and the function of which will be described below.

The piston 22 comprises a control rod 46, e.g. connected to the brake pedal (not shown) of the vehicle through a coupling sleeve 48, arranged at its free rear end. The control rod 46 may selectively travel within the moving piston 22, as a function of an input axial force, applied to the control rod 46 in the forward direction. The actuation force is exerted against a return force, applied to the rod 46 by a return spring 50, arranged between the moving piston 22 and the control rod 46. A bellows 51, disposed at the rear end 53 of the casing 12 and traversed by the control rod 46, seals off the rear end of the moving piston 22 from dust and foreign matters.

The free front end of the control rod 46 is shaped into a toggle 52, received in a housing 54 having a complementary shape and provided in a substantially cylindrical plunger 56, which is slidably mounted in the moving piston 22.

The plunger 56 bears, at its rear end, at least a rear annular seat 58 of a three-way valve 60, gradually movable between a position in which, the control rod 46 being at rest, the front chamber 16 and the rear chamber 18 are interconnected, and a position in which, the control rod 46 being actuated, the second pressure “P₂”, prevailing inside the rear chamber 18 increases because the valve 60 connects the rear chamber 18 with the atmospheric pressure “Pₐ”.

Since the mode of operation of the three-way valve 60 is known from the state of the art, it will not be further described herein.

In a well-known manner, the servomotor 10 comprises a first finger 62, which constitutes the front end of the plunger 56 and traverses the piston 22. More especially, the first finger 62 opens in the front face 26 of the piston 22, facing the reaction disk 44 accommodated in the cup 36.

FIG. 2 shows, in particular, that the plunger 56 comprises a front section 61, the end of which constitutes the first finger 62, an intermediate section 63 having a greater diameter than the front section, and a rear section 65, the rear end of which forms the seat 58 for the valve.

In the rest position of the control rod 46, illustrated in FIG. 2, the first finger 62 is disposed at a first determined jump distance “d1” from the reaction disk 44. When the control rod 46 is actuated at a speed which is lower than a determined speed, in a manner to be described hereunder, the first finger 62 is capable of accompanying the piston 22 on said first jump distance “d1” till, the piston 22 having fully compressed the reaction disk 44 inside the cup 36, the disk contacts the first finger 62 and transmits the reaction force from the master cylinder 28 to the control rod 46, as represented in FIG. 3.

According to this invention, the servomotor 10 comprises a tubular sleeve 64, slidably fitted on the plunger 56, having a front section 66 traversing the piston and an end 68 of which comprises a second finger, said sleeve being capable, when the control rod 46 is actuated at a higher speed than the determined speed, of being pushed by the plunger 56 and locked by a unidirectional clutch device 70 in an axial position, which is determined in relation to the piston 22, and then of being driven by the piston 22 so as to cause the second finger 68 to penetrate the reaction disk 44, as shown in FIG. 4, in order to enable the first finger 62 to apply a quick braking force against a reaction counter-force from the master cylinder 28, which is reduced on a second determined jump distance “d2”, which is greater than the first jump distance “d1”, as illustrated in FIG. 5.

To this end, the sleeve 64 is slidably fitted inside the piston 22 and, in the preferred embodiment of the invention, it is fully coaxial with the plunger 56. For this purpose, the sleeve 64 comprises a rear tubular section 72, which is slidably fitted within a complementary-shaped rear bore 74 provided in the piston 22.

In the preferred embodiment of the invention, the second finger 68 is coaxial with the plunger 56. Such arrangement is by no means limitative of the invention and the second finger 68 could be not coaxial with the plunger 56, as long as the front section 66 of the sleeve 64, which bears the second finger 68, is coaxial with the plunger 56.

Besides, in the preferred embodiment of the invention, the second finger 68 and the section 66 of the sleeve 64 are manufactured as a single piece from the same material. Such arrangement is by no means limitative of the invention and the second finger 68 could be just as well, as an alternative design (not shown), joined to the front section 66 of the sleeve 64.

In an advantageous manner, the second finger 68 has a greater outer diameter than that of the rear section 72 of the sleeve, said diameter having a dimension substantially between the diameter of the reaction disk 44 and that of the first finger 62.

Furthermore, the rear section 72 of the sleeve 64 comprises a bore 76, the diameter of which matches that of the intermediate section 63 of the plunger 56.

The unidirectional clutch device 70 comprises a key 78, which is fitted inside a cavity 80 provided in the piston 22 and traversing the piston 22, perpendicularly to its axis A, and a substantially annular intermediate portion 82 of which surrounds the sleeve 64 with some clearance. The key 78 comprises a substantially L-shaped lower portion 84, extending radially from the annular portion 82 and resiliently biased against a stop-forming face 86 provided in the casing 12 of the servomotor 10, through a return spring 88 arranged between a front face 90 of the cavity 80 provided in the piston 22 and a front face 92 of the lower portion 84.

More especially, the return spring 88 is disposed between the front face 90 of the cavity 80 and a vertical branch 94 of the L-shaped lower portion 84. An horizontal branch 96 of the L-shaped lower portion 84 is more particularly intended to abut against a stop-forming face 86 provided in the casing 12 of the servomotor 10.

In an advantageous manner, the stop-forming face 86 of the casing 12 is borne, e.g. by a ring 98, accommodated inside the cylindrical casing 12 of the servomotor 10. Such ring 98 may be close-fitted in the rear end of the casing 12.

As illustrated in FIG. 4, when the input force is applied to the control rod 46 at a speed, which is higher than the determined speed, the key 78 is capable of being driven by the moving piston 22, so as to rock about a generally transverse axis, in order to cooperate with the periphery of the rear tubular section 72 of the sleeve 64, thus locking said sleeve 64 in a determined axial position, in relation to the piston 22.

For this purpose, the rear tubular section 72 of the sleeve 64 comprises at least one locking transverse face 100, axially facing rearwards so as to constitute a stop for a peg 102 provided on an upper portion of the key 78 and extending radially towards the sleeve 64, for an axial indexing of the determined locking position of the sleeve 64 and of the second finger 68.

Therefore, the key 78 has substantially, in an axial sectional view, the shape of a tee, the vertical branch of which is substantially radially directed and comprises the annular intermediate portion 82 and the substantially L-shaped lower portion 84, whereas its upper horizontal branch 83, forming the upper portion, bears the peg 102, which protrudes from its front end, and is received, with some clearance, between two opposite walls 90, 91 of the cavity 80.

In an advantageous manner, the rear section 72 of the sleeve 64 comprises a groove 104 exhibiting a substantially truncated-cone-shaped profile, a shoulder-forming front face of which constitutes the locking transverse face 100.

Such arrangement is by no means limitative of the invention. In the preferred embodiment of the invention, the locking transverse face 100 exhibits an annular shape, but it could just as well consist of an angular portion or sector of an annular element, or of a flange, protruding from the sleeve 64, without altering either the characteristics of the invention, or the advantages provided by the invention.

Advantageously, as shown in FIG. 1 through 5, the truncated-cone shaped groove 104 exhibits a profile which merges progressively and smoothly into the cylindrical periphery of the rear section 72 of the sleeve 64.

On the other hand, the peg 102 borne by the key 78 has, in an axial sectional view, the shape of an angular sector, which is complementary to the truncated-cone-shaped profile of the groove 104 provided in the sleeve 64.

The truncated-cone shaped profiles of both the peg 102 and the groove 104 of the sleeve 64 are most advantageous in that they make it possible, on the rocking motion of the key 78, to guide the peg 102 of the key 78 till it reaches its abutting position against the shoulder-forming front face 100 of the sleeve 64.

Therefore, the servomotor 10 is capable of operating in various configurations, as shown in FIG. 2 through 5.

In the rest position of the control rod 46, illustrated in FIGS. 1 and 2, the horizontal branch 96 of the lower portion 84 of the key 78 rests on the stop-forming face 86 of the ring 98 integral with the casing 12 of the servomotor 10.

A transverse pin 106, traversing a hole (not shown) provided in the sleeve 64 and in the plunger 56, bears, in the rest position of the control rod 46, on a front face 107 of the annular intermediate portion 82 of the key 78 so as to define the rest position of the plunger 56, the first finger 62 of which forms, together with the reaction disk 44, the first jump distance “d1”.

In that way, as represented in FIGS. 3 through 5, when an input force is applied in the forward direction, in accordance with a full stroke of the control rod 46, the lower portion 84 of the key 78 separates from the stop-forming face 86, with the result that the key 78 rocks about a generally transverse axis anticlockwise so as to cooperate with the periphery of the sleeve 64.

If the input force is exerted in a comparatively slow manner, that is in the case of a normal braking operation, as shown in FIG. 3, the equalization of the pressures “P₁” and “P₂” inside the front and rear chambers of the servomotor 10 takes place substantially at the same speed as that at which the plunger 56 moves forwards owing to the actuation of the control rod 46. Therefore, the plunger 56 and the piston 22 travel at a substantially equal speed. As soon as the lower portion 84 of the key 78 no longer bears on the stop-forming face 86, the peg 102 provided on the key 78 falls down again on the periphery of the front section 66 of the sleeve 64, yet without locking it. The piston 22 compresses the reaction disk 44 and the latter becomes deformed so as to fill the cavity, which is formed in the sleeve 64, by the jump distance “d1”. The jump distance “d1” is completely covered when the reaction disk 44 cannot be compressed any more, when in contact with the first finger 62.

On the other hand, if the input force is applied at a higher speed than a determined speed, i.e. in the case of an emergency braking operation, the equalization of the pressures “P₁ ” and “P₂” prevailing inside the front and rear chambers of the servomotor 10 takes place more slowly than the speed at which the plunger 56 moves forwards owing to the actuation of the control rod 46.

It results in that, first of all, in a first step of initial actuation of the control rod, illustrated in FIG. 4, the plunger 56, which slides forwards in relation to the initially unmoved piston 22, pushes back the sleeve 64 by means of its rear section 65, and both fingers 62 and 68 move forwards in a simultaneous manner. The piston 22 moves off in turn and, as soon as the lower portion 84 of the key 78 no longer bears on the stop-forming face 86, the peg 102 provided on the key 78 falls down in the groove 104 made in the sleeve, which it locks in relation to the piston 22, by resting on its shoulder-forming transverse face 100.

It should be noted that, from that time onwards, the axial position of the second finger 68 in relation to the piston 22 is set by the engagement of the peg 102 with the groove 104.

Then, in a second step of intermediate actuation of the control rod, illustrated in FIG. 5, the piston 22 moves owing to the pressure rise inside the rear chamber 18 of the servomotor. Therefore, the second finger 68, driven by the sleeve 64, which is locked in relation to the piston 22, penetrates further into the reaction disk 44, whereas the first finger 62 remains substantially unmoved. Consequently, the second finger 68 compresses the reaction disk locally, with the result that the reaction disk 44 is decompressed locally, at the first finger 62.

Since the jump distance is characterised by the distance between the rest position of the first finger 62 and the position of the finger 62, in which it compresses the reaction disk 44, the finger 62 can still cover a second jump distance “d2”, which is greater than the above-mentioned first jump distance “d1”.

In the course of a third step of end actuation of the control rod 46, thus the first finger 62 is capable of re-compressing the reaction disk 44 locally, on the distance “d2”, till said disk 44 is not compressible any more. As a consequence, at the end of this third step, the configuration of the servomotor is similar to that represented in FIG. 4, with this exception that the piston 22 has been moved forwards inside the casing 12 of the servomotor 10.

In the present case, said second distance “d2” is much about the same as the distance separating the first finger 62 from the second finger 68, but the first finger 62 might just as well compress the reaction disk 44 only after having passed the second finger 68, such a possibility being dependent on the mechanical properties of the elastomeric material, which the reaction disk 44 is made of.

At all events, such distance “d2” will be covered by the first finger 62, while under a reaction counter-force from the master cylinder, which is reduced because the reaction disk 44 is kept in a compressed state at the second finger 68, locked by the key 78.

Therefore, such configuration enables the driver to exert a braking force very quickly, without an excessive physical effort to oppose the reaction counter-force from the master cylinder.

Thus, the servomotor 10 is characterised by two differentiated jump distances, namely a first jump distance “d1”, for the application of a braking force at a slow speed only, and a second jump distance “d2”, for the application of a braking force at a high speed only.

Of course, when the control rod 46 is completely released, which means that the piston 22 moves backwards, the lower portion 84 of the key is returned into contact with the stop-forming face 86 of the ring 98, thus unlocking the sleeve 64 which resumes a position as per FIG. 2.

Therefore, in an advantageous manner, the present invention gives the benefit of a maximum braking force, whatever the circumstances may be.

1. Pneumatic servomotor (10) for the actuation of a braking master cylinder (28) in a motor vehicle,
of the type comprising a rigid casing (12), in which a transverse partition wall (14) is movable, thus defining in an airtight manner a front chamber (16) under a first engine negative pressure (P₁), and a rear chamber (18) under a second pressure (P₂), varying between the engine negative pressure and the atmospheric pressure (Pₐ);
of the type including a moving piston (22), integral with the moving partition wall (14) and a front face (26) of which is capable of biasing an actuating rod (34) for the master cylinder (28);
of the type including a control rod (46) for the servomotor (10), moving inside the piston (22), in a selective manner as a function of an axial input force, exerted in the forward direction against a return force applied to the rod (46) by a return spring (50);
of the type comprising a plunger (56), which is arranged at the front part relative to the control rod (46) inside the piston (22), and which comprises at its rear end at least a rear annular seat (58) of a three-way valve (60), gradually movable between a position in which, the control rod (46) being at rest, the front chamber (16) and the rear chamber (18) are interconnected, and a position in which, the control rod (46) being actuated, the second pressure (P₂), prevailing within the rear chamber (18), increases because the valve (60) connects the rear chamber (18) with the atmospheric pressure (Pₐ);
and of the type comprising a first finger (62) which constitutes the front end of the plunger (56) and traverses the piston (22), and which, in the rest position of the control rod (46), is disposed at a first determined jump distance (d1) from a reaction disk (44), interposed between the actuating rod (34) for the master cylinder (28) and the front face (26) of the moving piston (22) and which, when the control rod (46) is actuated at a speed which is lower than a determined speed, is capable of being biased by the plunger (56) so as to cover the first jump distance (d1) and then penetrate the reaction disk (44) in order to transmit the reaction force from the master cylinder (28) to the plunger (56) and to the control rod (46)
characterised in that it comprises a tubular sleeve (64), slidably fitted on the plunger (56), and having a front section (66) traversing the piston (22) and an end of which comprises a second finger (68), wherein, when the control rod (46) is actuated at a higher speed than a determined speed, said sleeve is capable of being pushed by the plunger (56) and locked by a unidirectional clutch device (70) in an axial position, which is determined in relation to the piston (22), and then of being driven by the piston (22) so as to cause the second finger (68) to penetrate the reaction disk (44), in order to enable the first finger (52) to apply a quick braking force against a reaction counter-force from the master cylinder (28), which is reduced on a second determined jump distance (d2), which is greater than the first jump distance (d1).

2. Servomotor (10) according to the preceding claim, characterised in that the sleeve (64) comprises a rear tubular section (72), which is slidably fitted within a complementary-shaped rear bore (74) provided in the piston (22).

3. Servomotor (10) according to the preceding claim, characterised in that the unidirectional clutch device (70) comprises a key (78), fitted inside a cavity (80) provided in the piston (22) and traversing the piston (22), perpendicularly to its axis (A), and a substantially annular intermediate portion (82) of which surrounds the sleeve (64) with some clearance and is capable of being driven by the moving piston (22), when the input force is applied to the control rod (46) at a speed, which is higher than the determined speed, so as to rock about a generally transverse axis, in order to cooperate with the periphery of the rear tubular section (72) of the sleeve (64), thus locking said sleeve (64) in the determined axial position.

4. Servomotor (10) according to the preceding claim, characterised in that the rear tubular section (72) of the sleeve (64) comprises at least one locking transverse face (100), axially facing rearwards so as to constitute a stop for a peg (102) provided on an upper portion of the key (78) and extending radially towards the sleeve (64), for an axial indexing of the determined locking position of the sleeve (64) and of the second finger (68).

5. Servomotor (10) according to the preceding claim, characterised in that the rear section (72) of the sleeve comprises a groove (104) exhibiting a substantially truncated-cone-shaped profile, a shoulder-forming front face of which forms the locking transverse face (100).

6. Servomotor (10) according to the preceding claim, characterised in that the peg (102) provided on the key has, in an axial sectional view, the shape of an angular sector, which is complementary to the truncated-cone-shaped profile of the groove (104) in the sleeve (64).

7. Servomotor (10) according to claim 3, characterised in that the key (78) comprises a substantially L-shaped lower portion (84), diametrically opposite the peg (102), extending radially from its annular portion (82) and resiliently biased against a stop-forming face (86) provided in the casing (12) of the servomotor (10), through a return spring (88), arranged between a front face (90) of the cavity (80) provided in the piston (22) and a front face (92) of said lower portion.

8. Servomotor (10) according to claim 2, characterised in that the second finger (68) has a greater outer diameter than that of the rear section (72) of the sleeve (64).

9. Servomotor (10) according to the preceding claim, characterised in that the reaction disk (44) is received within a cup (36), coaxial with the piston (22) and integral with the rear end (38) of the actuating rod (34), an a rear tubular portion (40) of which is slidably fitted inside an annular groove (42), coaxial with the front face (26) of the piston (22).

10. Servomotor (10) according to the preceding claim;, characterised in that the key (78) has, in an axial sectional view, the shape of a tee, the vertical branch of which is substantially radially directed and comprises the annular intermediate portion (82) and the substantially L-shaped lower portion (84), whereas its upper horizontal branch (83) bears the peg (102), which protrudes from its front end, and is received, with some clearance, between two opposite walls (90, 91) of the cavity (80).
